(19) United States
(12) Patent Application Publication
(10) Pub. No.: US 2013/0032270 A1
(43) Pub. Date: Feb. 7, 2013

(54) THERMAL COMPRESSION BONDING WITH SEPARATE BOND HEADS

(71) Applicant: KAZUAKI MAWATARI, BEPPU-CITY (JP)

(72) Inventor: KAZUAKI MAWATARI, BEPPU-CITY (JP)

(73) Assignee: TEXAS INSTRUMENTS INCORPORATED, Dallas, TX (US)

(21) Appl. No.: 13/195,164

(22) Filed: Aug. 1, 2011

(51) Int. Cl. B29C 65/02; B23K 1/00

(52) U.S. Cl. 156/60; 228/101; 156/583.1

(57) ABSTRACT

A method of thermocompression (TC) bonding includes heating a semiconductor die and a substrate with at least one TC bondable material at an interface between the semiconductor die and the substrate with a bond head apparatus including a first portion and a second portion. The semiconductor die and TC bondable material or product therefrom are then cooled by removing the first portion from contacting the semiconductor die while maintaining the second portion of the bond head apparatus on the semiconductor die.

### FIELD

Disclosed embodiments relate to assembly involving thermocompression bonding of semiconductor die.

### BACKGROUND

Thermocompression (TC) bonding is a technique involving the simultaneous application of a predetermined amount of heat and pressure at the interface between two mating articles so as to effect a fusion type bond therebetween. TC bonding can be used to form solder comprising joints, and other metal joints (e.g., gold-to gold).

A conventional TC bonder includes a single bond head that during TC bonding applies both heat and pressure. The bond head includes a vacuum hole that allows a vacuum to be applied which secures a semiconductor (e.g., integrated circuit (IC)) die to the bond head for semiconductor assembly operations. The bond head remains in contact with the semiconductor die during both heating and cooling. For solder applications, contact during cooling helps prevent solder deformation and die movement before solidification of the solder.

However, the relatively large thermal mass of the hot bond head results in slow bond head cooling and heating of the semiconductor die and solder during cooling that delays solder solidification. Delayed solidification results in a total processing time that may be 20 to 40 seconds, or more, with the cooling process being the longest portion of the overall TC bonding process.

TC bonding can also be used with thermoset materials, such as certain die attach pastes, which can be provided as conductive pastes, or non-conductive pastes, for some assembly processing. One example process is flip chip bonding with a thermoset material. In this process an IC transfer rubber collet picks up the active topside of the semiconductor die having the thermoset material thereon. The collet/die is flipped and is then placed so that the die is in contact with a bond head, and the collet is then removed from the die. However, if the bond head is sufficiently hot (e.g., ≧100° C.) when the die is placed in contact with the bond head there is a risk of sticking to the rubber collet. Accordingly, such processes may add a period of time to allow the bond head to cool sufficiently before die contact to reduce the chance of film sticking.

### SUMMARY

Disclosed embodiments describe thermal compression (TC) bonding with a TC bonding apparatus that includes at least a first TC bond head and at least a second TC bond head separate from the first TC bond head. Separate bond heads have been found significantly reduce the problem of long process times for TC bonding by removing a portion of the bond head thermal mass used during heating for the cooling process, while still securing the semiconductor die to the substrate during cooling.

Disclosed embodiments include a TC bonding method comprising heating a semiconductor die and a substrate with a bond head apparatus comprising a first portion and a second portion, wherein at least one TC bondable material is at an interface between the semiconductor die and the substrate. The semiconductor die and TC bondable material or a product therefrom are then cooled by removing the first portion of the bond head apparatus from contacting the semiconductor die while maintaining the second portion of the bond head apparatus on the semiconductor die.

### BRIEF DESCRIPTION OF THE DRAWINGS

FIG. 1A is a side view depiction of an example TC bond head apparatus having separate bond heads, while FIG. 1B a top view depiction of the example TC bond head apparatus shown in FIG. 1A, according to an example embodiment.

FIG. 1C is a side view depiction of another example TC bond head apparatus having separate bond heads, while FIG. 1D a top view depiction of the example TC bond head apparatus shown in FIG. 1C, according to an example embodiment.

FIG. 2A-E provide successive depictions showing steps for an example method of TC bonding, according to an example embodiment.

FIG. 3 is a plot of temperature vs. time during the cooling step for a conventional TC bonding method that uses a conventional single bond head as compared to a disclosed TC bonding process using a TC bonding apparatus having separate TC bond heads that evidences substantially faster cooling.

FIG. 4 is a depiction of an example TC bond head apparatus including a first TC bond head and at least a second TC bond head spaced apart from the first TC bond head, with separate control heads for controlling a vertical position of the respective TC bond heads independent of one another, according to an example embodiment.

### DETAILED DESCRIPTION

Example embodiments are described with reference to the drawings, wherein like reference numerals are used to designate similar or equivalent elements. Illustrated ordering of acts or events should not be considered as limiting, as some acts or events may occur in different order and/or concurrently with other acts or events. Furthermore, some illustrated acts or events may not be required to implement a methodology in accordance with this disclosure.

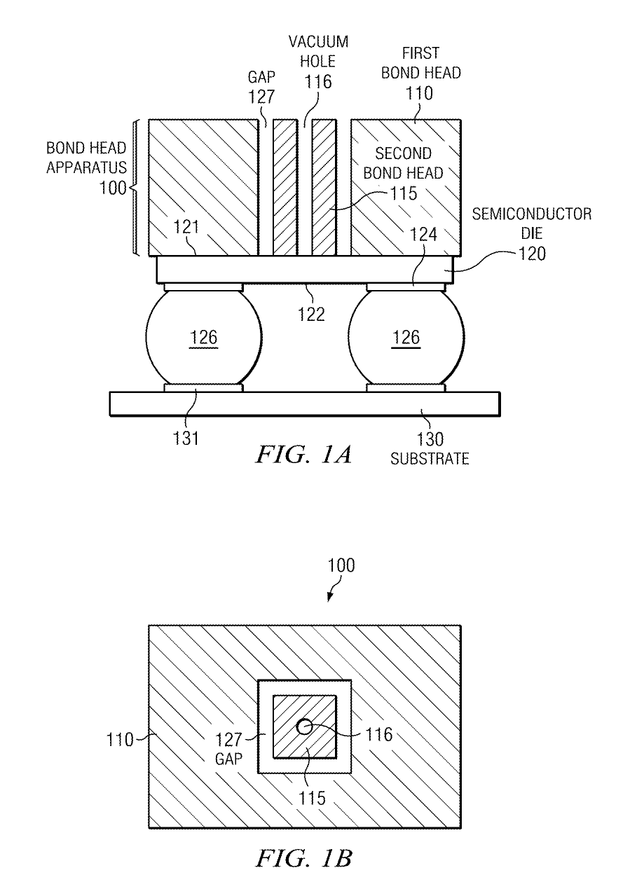

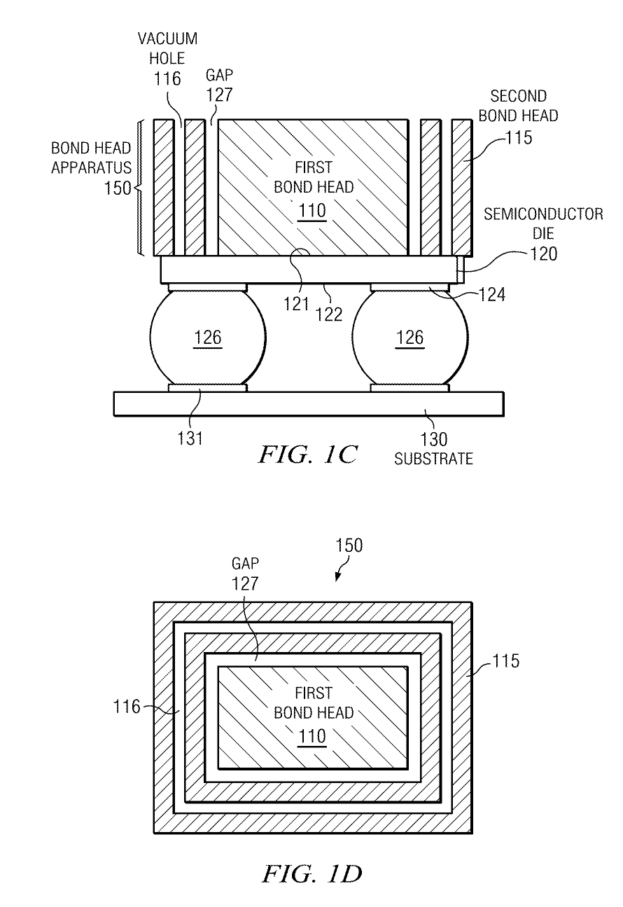

FIG. 1A is a side view depiction of an example TC bond head apparatus 100 having separate first portions and second portions while performing TC bonding of pads or other bondable features 124 on a semiconductor die 120 to pads 131 on a substrate 130, while FIG. 1B is a top view depiction of the example TC bond head apparatus 100 shown in FIG. 1A, according to an example embodiment. First portions and second portions are shown as first TC bond head 110 and second TC bond head 115, respectively. TC bond head apparatus 100 is shown with the first TC bond head 110 having a larger mass as compared to the mass of second TC bond head 115, and to be positioned outside the smaller mass second TC bond head 115. Although TC bond head apparatus 100 is shown bonding a single semiconductor die 120, disclosed embodiments also include bonding a wafer including a plurality of semiconductor die, or stacked die.

Both TC bond heads 110, 115 of the TC bond head apparatus 100 are shown in FIG. 1A in contact with a first side 121 of semiconductor die 120. A second side 122 of the semiconductor die 120 opposite the first side 121 is on the substrate 130. A TC bondable material shown as solder in the form solder balls 126 is interposed between bonding pads or other bondable features 124 on the second side 122 of semiconductor die 120 and the pads 131 on the substrate 130.

As used herein, a “TC bondable material” can be provided by the semiconductor die, the substrate, both the semiconductor die and the substrate, or can be provided by a layer between the semiconductor die 120 and the substrate 130. Such materials under appropriate heat and pressure conditions applied during TC bonding undergo migration or a change in state that results in sticking together at the interface between the semiconductor die 120 and the substrate 130. In the case of metal materials, under TC bonding conditions metal atoms migrate from one crystal lattice to the other one based on a diffusion process, while in the case of thermoset polymer precursors (monomers) polymerization takes place that forms a thermoset polymer that bonds the interface.

Substrate 130 can comprise a wide variety of substrates, included printed circuit boards (PCBs), organic and ceramic substrates, leadframes, and die, including stacked die (e.g., on a carrier wafer). Other substrate examples include a silicon interposer, glass wafer and tape (e.g., polyimide) substrate.

Second TC bond head 115 includes a vacuum hole 116 for coupling a vacuum source that pulls a vacuum for securing the semiconductor die 120 to the TC bond head apparatus 100. There is a gap 127 between TC bond heads 110 and 115 that provides separation to permit independently moving the respective TC bond heads, and if desired independently heating as well. The first TC bond head 110 and second TC bond head 115 are shown concentric, with said second TC bond head 115 being an inner bond head and the first TC bond head 110 being an outer bond head. The size of the first TC bond head 110 is depicted as being larger as compared to the second TC bond head 115 so that the mass of the first TC bond head 110 is greater than the mass of the second TC bond head 115. In one embodiment the mass of the first TC bond head 110 is at least ten (10) times greater than the mass of the second TC bond head 115.

FIG. 1C is a side view depiction of another example TC bond head apparatus 150 having separate bond heads while performing TC bonding of pads or other bondable features 124 on a semiconductor die 120 to pads 131 on a substrate 130, while FIG. 1D a top view depiction of the example TC bond head apparatus 150 shown in FIG. 1C, according to an example embodiment. TC bond head apparatus 150 is shown having the larger mass first TC bond head 110 to be inside the smaller mass second TC bond head 115.

Although the example TC bond head apparatus 100 and 150 are shown having two TC bonds heads 110, 115 that are concentric with another, disclosed bond head apparatus can have three or more bond heads, or can be configured in non-concentric arrangements. For example, the respective TC bond heads can be configured side-by-side, or include three or more bond heads, such as comprising outer bond head, and inner bond head, and another bond head between the outer bond head and inner bond head.

Although TC bond head apparatus 100 and 150 are shown forming a solder joint in FIGS. 1A and 1C, disclosed bond head apparatus can be used for other TC bonding processes. Example TC bonding processes include forming other metal joints, such as gold or other metals (e.g., copper) to solder, and gold to gold. TC processing can also involve thermoset polymers, such as for flip chip TC bonding. For example, the thermoset materials can comprise epoxies (thermoset precursors), in either non-electrically/thermally conductive or electrically/thermally conductive (e.g., including metal particles) forms, that polymerize upon TC bonding.

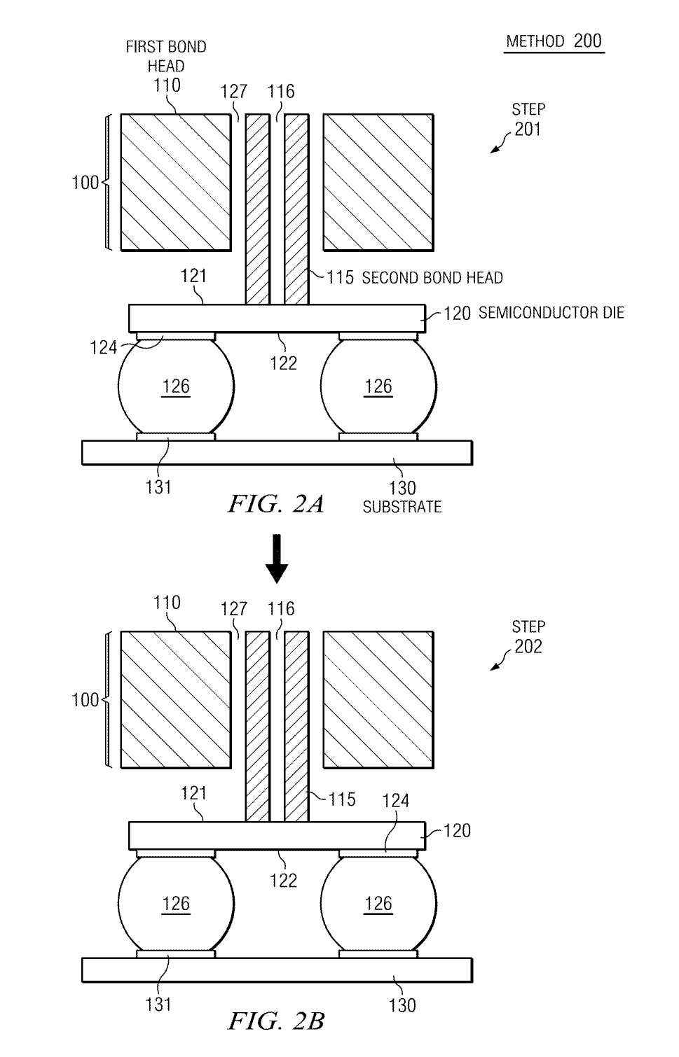

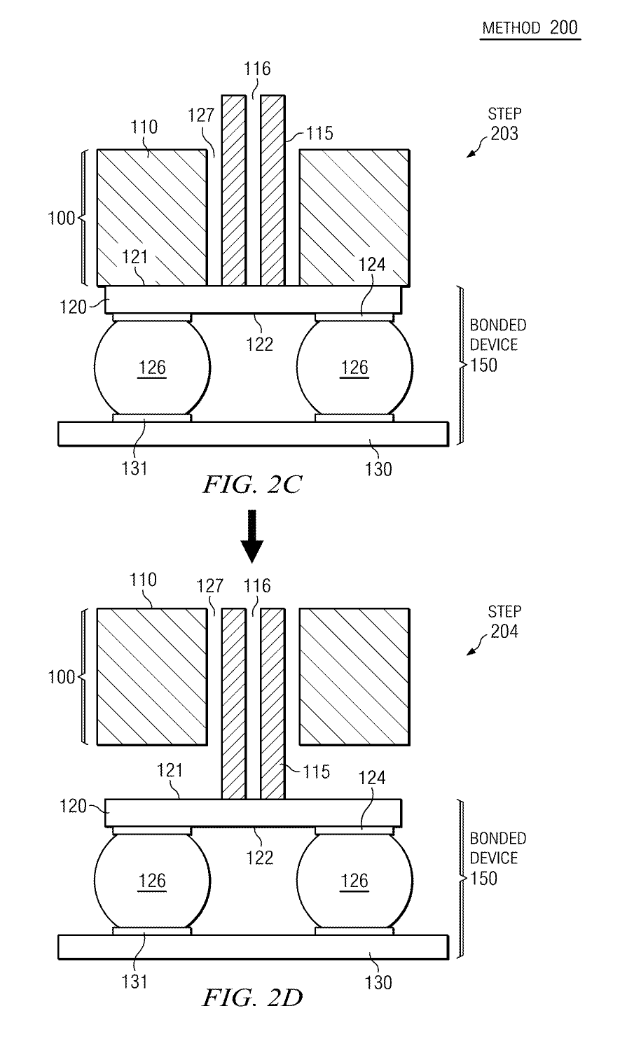

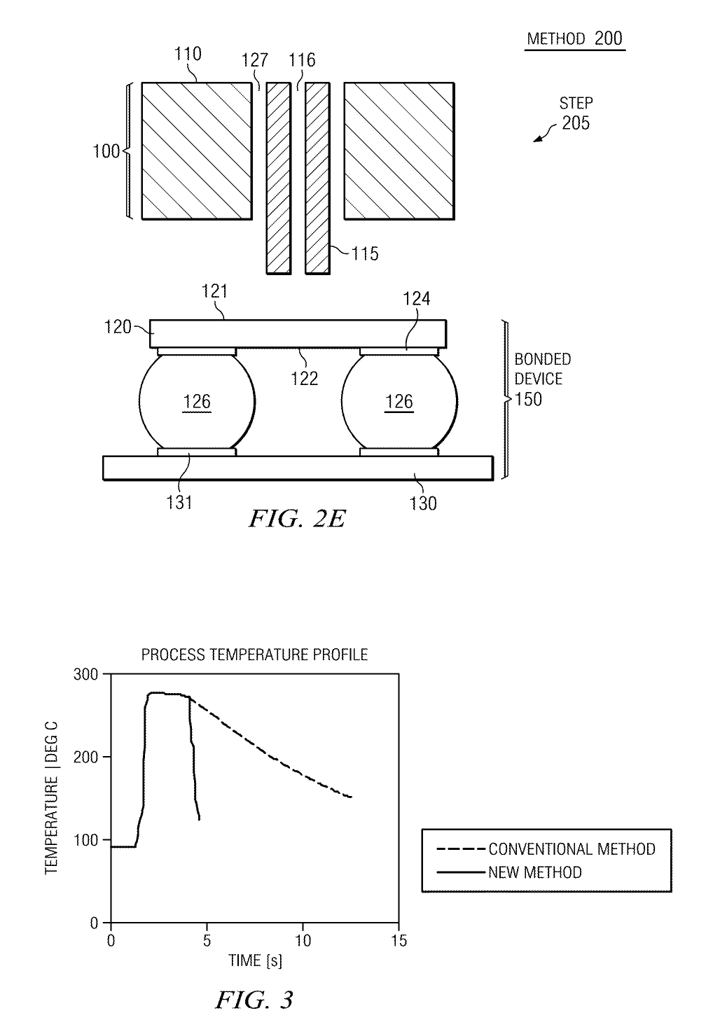

FIGS. 2A-E provide successive depictions showing steps for an example method 200 of TC bonding using the TC bond head apparatus 100 shown in FIGS. 1A and 1B, according to an example embodiment. Method 200 comprises steps 201-205. Step 201 depicted in FIG. 2A shows the second TC bond head 115 in contact with and holding the semiconductor die 120 having solder balls 126 on second side 122 via a vacuum applied through vacuum hole 116, where the semiconductor die 120 is held above the substrate 130 so that the solder balls 126 are positioned above the substrate 130. First TC bond head 110 and second TC bond head 115 can be held at different constant temperatures throughout the duration of the TC bonding, such as 320 to 400° C. for first TC bond head 110 and 30 to 150° C. for second TC bond head 115 for TC bonding to form certain solder joints.

Having first TC bond head and second TC bond head at different temperatures enables transfer of semiconductor die to the TC bond head apparatus 100 at a selectable low temperature, that is set by controlling the temperature of the second TC bond head 115 which is the only TC bond head used for the die transfer. Low temperature die transfer provides certain advantages. For solder applications, if transfer of semiconductor die to the TC bond head is performed at a temperature of at least about 150° C., there is a risk for solder deformation. Similarly, in the case of a semiconductor die having a film thereon, such as a conductive or non-conductive film, or a die attach film, such films can stick to the rubber transfer collet, such as at temperatures of at least about 100° C. Selecting the temperature of the second TC bond head 115 to be below the temperature that risks problems upon die transfer can improve assembly operations, including yield for some products (e.g., semiconductor die having a fine ball pitch).

Step 202 depicted in FIG. 2B shows the second TC bond head 115 in contact with semiconductor die 120 via a vacuum, after the vertical position of the second TC bond head 115 is lowered so that the solder balls 126 on second side 122 of the semiconductor die 120 are brought into contact with pads 131 on the substrate 130. First TC bond head 110 is shown remaining above the first side 121 of the semiconductor die 120.

Step 203 depicted in FIG. 2C shows both the first TC bond head 110 and the second TC bond head 115 in contact with semiconductor die 120, after the vertical position of the first TC bond head 110 is lowered to contact the first side 121 of the semiconductor die 120. In this arrangement, TC bonding is generally accomplished by including a predetermined time at a predetermined temperature, together with a predetermined pressure, to TC bond the bonding pads or other bondable features 124 the semiconductor die 120 to pads 131 on the substrate 130 to form a bonded device 160. In the embodiment the first TC bond head 110 is held at a constant high temperature (as compared to the temperature of second TC bond head 115) throughout method 200, the heating rate provided by TC bond head apparatus 100 can be significantly above a conventional bond head that is ramped in temperature during the heating step.

Step 204 depicted in FIG. 2D shows the second TC bond head 115 in contact with semiconductor die 120 via a vacuum, after the vertical position (height) of the first TC bond head 110 is raised to be positioned above the first side 121 of the semiconductor die 120. In this arrangement, the bonded device 160 including the heated joint is cooled, where the second TC bond head 115 holds the bonded device 160. In the case of the solder joints associated with bonded device 160, the cooling proceeds a sufficient time to achieve solidification of the solder. Since the thermal mass of the first TC bond head 110 is removed from contact with bonded device 160 while cooling in step 204, the cooling rate is increased compared to a conventional single bond head arrangement. More rapid cooling improves throughput of the TC bonding system, and can also improve product yield and reliability, such as by preventing shrinkage of solder.

Step 205 depicted in FIG. 2E shows the TC bond head apparatus 100 having both the first TC bond head 110 and second TC bond head 115 having a vertical position above the bonded device 160 so that neither bond head is in contact with the bonded device 160. Method 200 can then be repeated on another semiconductor die and substrate.

The first TC bond head 110 can be held at a constant temperature that is above a constant temperature of the second TC bond head 115 during a full duration of at least step 203 which provides heating and pressure. The first TC bond head 110 and second TC bond head 115 can be maintained at their respective constant temperatures during a full duration of the heating and cooling, and in one embodiment for the full duration of method 200.

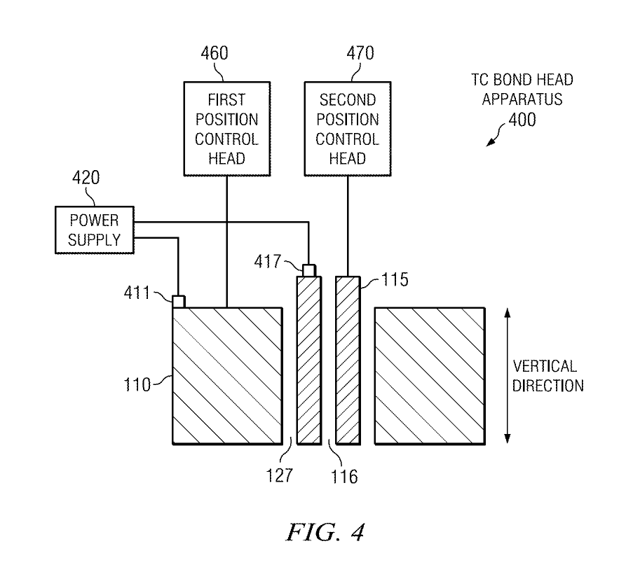

Switching between steps in method 200 can be automated through inclusion of appropriate sensors and actuators. The vertical positioning of the respective bond heads can be controlled by a vertical position control head, such as separate vertical position control heads (described below relative to FIG. 4).

FIG. 3 is a plot of temperature vs. time during the cooling (step 204 in method 200) for a conventional TC bonding method that uses a conventional single bond head as compared to a disclosed TC bonding method (shown as “new method”) using a TC bonding apparatus such as TC bond head apparatus 100 having separate bond heads that evidences substantially faster cooling. The cooling rate can be seen to be nearly eight times faster using a disclosed TC bond head apparatus.

FIG. 4 is a depiction of an example TC bond head apparatus 400 comprising a first TC bond head 110 having first connectors 411 for receiving applied current for heating the first TC bond head 110 and at least a second TC bond head 115 spaced apart from the first TC bond 110 head having second connectors 417 for receiving applied current for heating the second TC bond head 115. A power supply 420 is shown providing the current to the respective TC bond heads. A first position control head 460 is coupled to the first TC bond head 110 to control its vertical position, and a second position control head 470 is coupled to the second TC bond head 115 for controlling its vertical position independent of the vertical position of the first TC bond head 110. In another embodiment, a single position control head provides multiple channels to independently control the vertical position of the first TC bond head 110 and the second TC bond head 115.

Disclosed embodiments can be integrated into a variety of assembly flows to form a variety of different IC devices and related products. The IC assembly can comprise single semiconductor die or multiple semiconductor die, such as PoP configurations comprising a plurality of stacked semiconductor die. A variety of package substrates may be used. The semiconductor die may include various elements therein and/or layers thereon, including barrier layers, dielectric layers, device structures, active elements and passive elements including source regions, drain regions, bit lines, bases, emitters, collectors, conductive lines, conductive vias, etc. Moreover, the semiconductor die can be formed from a variety of processes including bipolar, CMOS, BiCMOS and MEMS.

Those skilled in the art to which this disclosure relates will appreciate that many other embodiments and variations of embodiments are possible within the scope of the claimed invention, and further additions, deletions, substitutions and modifications may be made to the described embodiments without departing from the scope of this disclosure. For example, an external cooling nozzle can be added to implement external cooling.

I claim:

1. A method of thermocompression (TC) bonding, comprising:
heating a semiconductor die and a substrate with at least one TC bondable material at an interface between said semiconductor die and said substrate with a bond head apparatus comprising a first portion and a second portion, and
cooling said semiconductor die and said TC bondable material or product therefrom by removing said first portion of said bond head apparatus from contacting said semiconductor die while maintaining said second portion of said bond head apparatus on said semiconductor die.

2. The method of claim 1, wherein said first portion comprises a first TC bond head and said second portion comprises at least a second TC bond head spaced apart from said first TC bond head, and wherein a mass of said first TC bond head is greater than a mass of said second TC bond head.

3. The method of claim 2, wherein said first TC bond head is at a first constant temperature that is above a second constant temperature of said second TC bond head during a full duration of at least said heating.

4. The method of claim 3, wherein said first TC bond head and said second TC bond head are both maintained at said constant temperatures during a full duration of said cooling.

5. The method of claim 1, wherein said first TC bond head is at a first constant temperature that is above a second constant temperature of said second TC bond head during a full duration said method.

6. The method of claim 1, wherein said TC bondable material comprises solder.

7. The method of claim 1, wherein said TC bondable material comprises a thermoset polymer precursor.

8. The method of claim 2, wherein said first TC bond head and said second TC bond head are concentric, with said second TC bond head being an inner bond head and said first TC bond head being an outer bond head.

9. A method of thermocompression (TC) bonding, comprising:
heating a semiconductor die and a substrate with at least one TC bondable material at an interface between said semiconductor die and said substrate with a bond head apparatus including a first TC bond head and at least a second TC bond head spaced apart from said first TC bond head,
wherein said first TC bond head is at a first constant temperature that is above a second constant temperature of said second TC bond head during said heating, and a mass of said first TC bond head is greater than a mass of said second TC bond head, and
cooling said semiconductor die and said TC bondable material or product therefrom by removing said first TC bond head from contacting said semiconductor die while maintaining said second TC bond head on said semiconductor die.

10. The method of claim 9, wherein said first TC bond head and said second TC bond head are both maintained at said constant temperatures during a full duration of said cooling.

11. The method of claim 9, wherein said first TC bond head is at said first constant temperature and said second TC bond head is at said second constant temperature during a full duration said method.

12. The method of claim 9, wherein said first TC bond head and said second TC bond head are concentric, with said second TC bond head being an inner bond head and said first TC bond head being an outer bond head.

13. A bond head apparatus, comprising:
a first thermocompression (TC) bond head having first connectors for receiving applied current for heating said first TC bond head;
at least a second TC bond head spaced apart from said first TC bond head having second connectors for receiving applied current for heating said second TC bond head, and
at least one position control head for coupling to said first TC bond head for controlling a vertical position of said first TC bond head, and coupling to said second TC bond head for controlling a vertical position of said second TC bond head independent of said vertical position of said first TC bond head.

14. The bond head apparatus of claim 13, wherein said at least one position control head comprises:
a first control head coupled to said first TC bond head for controlling said vertical position of said first TC bond head, and
a second control head coupled to said second TC bond head for controlling said vertical position of said second TC bond head independent of said vertical position of said first TC bond head.

15. The bond head apparatus of claim 13, wherein said first TC bond head and said second TC bond head are concentric, with said second TC bond head being an inner bond head and said first TC bond head being an outer bond head.

16. The bond head apparatus of claim 13, wherein a mass of said first TC bond head is greater than a mass of said second TC bond head.

17. The bond head apparatus of claim 16, wherein said mass of said first TC bond head is at least ten times greater than said mass of said second TC bond head.
